(19) United States
(12) Patent Application Publication
(10) Pub. No.: US 2023/0234209 A1
(43) Pub. Date: Jul. 27, 2023

(54) MAGNETIC DRILL PRESS

(71) Applicant: BLACK & DECKER INC., New Britain, CT (US)

(72) Inventors: Bingxin LUO, Suzhou (CN); Yuelong XU, Suzhou (CN); Qingyang LI, Suzhou (CN); Karen Marie BAUMEISTER, Jarrettsville, MD (US); Robert MURRAY, Towson, MD (US)

(21) Appl. No.: 18/190,174

(22) Filed: Mar. 27, 2023

Related U.S. Application Data
(63) Continuation of application No. PCT/US2022/070128, filed on Jan. 11, 2022.
(60) Provisional application No. 63/135,848, filed on Jan. 11, 2021.

(51) Int. Cl. B25H 1/00; B23B 39/02

(52) U.S. Cl. CPC B25H 1/0071; B23B 39/02; B23B 2270/022; B23B 2260/10; B23B 2270/08

(57) ABSTRACT

A drill press has a main housing, a drill unit supported by the main housing for relative movement therewith, and a base coupled to the main housing, the base includes a magnet assembly to create a magnetic field for magnetically latching the base to a workpiece. The magnet assembly is rotatably attached to the base and includes a shaft and at least one permanent magnet disposed on the shaft. The shaft is rotatable between a first position where the base would not magnetically engage the workpiece and a second position where the base would engage the workpiece. An auxiliary handle is pivotably attached to the main housing and movable from a first handle position preventing removal of a power tool battery pack from the main housing and a second handle position allowing removal of the power tool battery pack from the main housing.

### FIELD

The present disclosure relates to a power tool and, more particularly, to magnetic drill presses.

### DRAWINGS

The drawings described herein are for illustrative purposes only of selected embodiments and not all possible implementations, and are not intended to limit the scope of the present disclosure.

FIG. 1 is a side view of a first embodiment of a magnetic drill press according to the invention;

FIG. 2 illustrates a base of the magnetic drill press of FIG. 1;

FIG. 3 illustrates a magnet assembly of the magnetic drill press of FIG. 1;

FIG. 4 illustrates the operation of the magnet assembly of FIG. 3, where FIGS. 4A-4B show the magnet assembly in disengaged and engaged positions, respectively;

FIGS. 5A-5B illustrates the operation of a switch assembly in relationship with the magnet assembly of FIG. 3, where FIGS. 5A-5B show the magnet assembly in disengaged and engaged positions, respectively;

FIG. 6 is a cross-sectional view of a lever assembly for moving the magnet assembly between the disengaged and engaged positions;

FIG. 7 is a perspective view of a rear panel that engages the lever assembly of FIG. 6;

FIGS. 8A-8B illustrates the operation of the lever assembly of FIG. 6, where FIGS. 8A-8B show the magnet assembly in the disengaged and engaged positions, respectively;

FIG. 9 is a side perspective view of a second embodiment of a magnetic drill press according to the invention;

FIG. 10 is a close-up view of the magnetic drill press of FIG. 9;

FIG. 11 is a perspective view of an auxiliary handle of the magnetic drill press of FIG. 9;

FIGS. 12A-12B illustrates a detent assembly for the auxiliary handle of FIG. 11, where FIGS. 12A-12B are perspective views without and with a handle insert, respectively;

FIG. 13 is a cross-sectional view of the auxiliary handle and detent assembly; and

FIG. 14 is a side view of a coolant reservoir assembly for the magnetic drill press of FIG. 9.

Corresponding reference numerals indicate corresponding parts throughout the several views of the drawings.

### DETAILED DESCRIPTION

Example embodiments will now be described more fully with reference to the accompanying drawings.

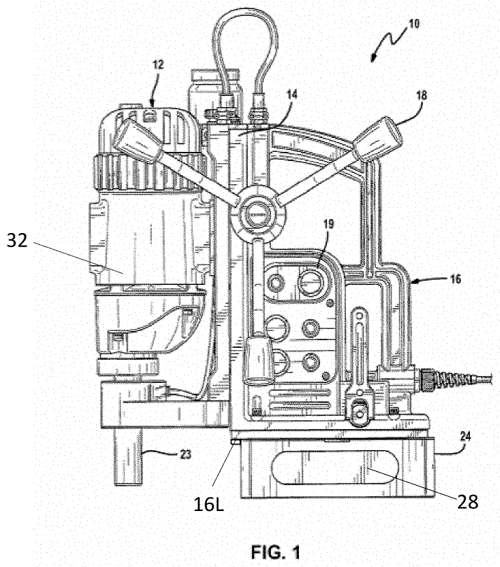

FIG. 1 illustrates a magnetic drill press 10, generally comprising a motor carriage 12 attached to a rack 14 of a housing 16. An electric motor, along with a drilling mechanism 23, is housed within the motor carriage 12. The electric motor 32 rotatably drives the drilling mechanism 23. In an example embodiment, the drilling mechanism is a tool bit holder 23 configured to hold an accessary, such as a drill bit. While reference is made throughout this disclosure to a drill press, it is readily understood that concepts described herein are, applicable to other types of power tools which may make use of an electromagnetic attachment mechanism. Persons skilled in the art are referred to U.S. Pat. No. 9,561,568, titled “MAGNETIC DRILL PRESS WITH ALTERNATE POWER SOURCE,” issued on Feb. 7, 2017, which is hereby incorporated by reference, for further details on drill presses.

During operation, the tool operator moves the tool into engagement with a workpiece by moving the motor carriage 12 vertically up and down (in the orientation illustrated in FIG. 1) along the rack 14. More specifically, the tool operator may actuate a handle 18, which is interfaced with the rack 14, to move the motor carriage 12 toward and away from the workpiece. The housing 16 also supports multiple switches or buttons for controlling the operation of the tool, including a power on/off button 19 for coupling/decoupling current to the drill press 10.

With continued reference to FIG. 1, the drill press 10 is further configured with a base 24 to secure the drill press 10 to a work surface. The base 24 houses a magnet assembly 28. Persons skilled in the art shall recognize that magnet assembly 28 may be an electromagnet or a permanent magnet. When the drill press 10 is placed onto a work surface, the magnet assembly 28 is positioned proximate thereto. If magnet assembly 28 is an electromagnet, the magnet assembly 28 preferably magnetically couples the base 24 of the drill press 10 to the work surface in response to an energizing signal.

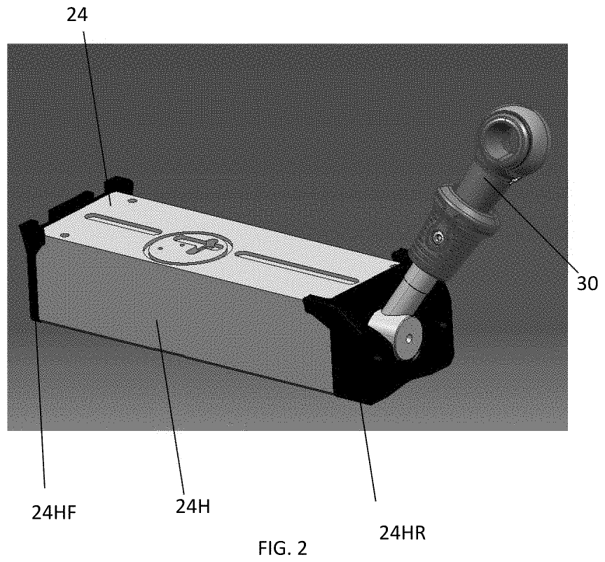

Referring to FIGS. 2-4, base 24 is preferably removably attached to housing 16. Base 24 may have a housing 24H that preferably carries a magnet assembly 28 rotatably attached thereto.

Preferably magnet assembly 28 has a shaft 28S, rotatably disposed between front and rear panels 24HF, 24HR of housing 24H. To minimize friction between shaft 28S and front and rear panels 24HF, 24HR, it is preferably to provide front and rear panels 24HF, 24HR with respective bearings 24HFB, 24HRB contacting shaft 28S.

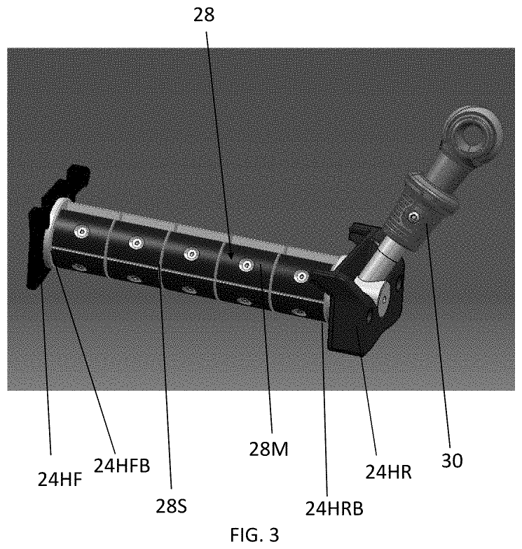

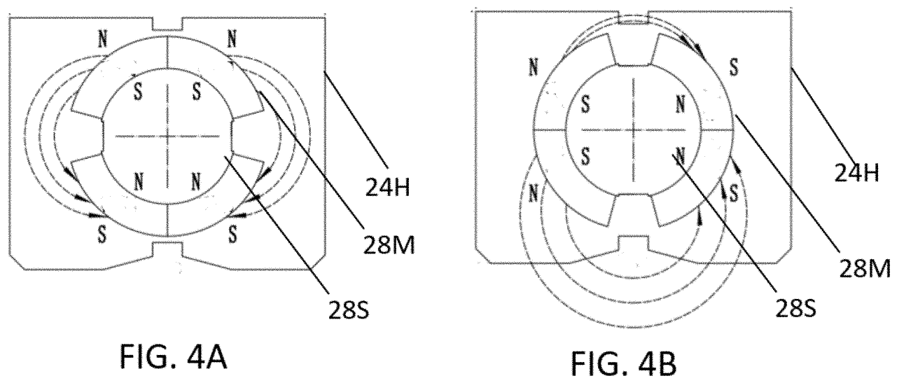

In addition, magnets 28M are disposed on shaft 28S. Preferably magnets 28M are permanent. As shown in FIGS. 3-4B, magnets 28M may be shaped as a half- or quarter circle, and arranged on shaft 28S so that almost one half of the perimeter of shaft 28S is covered with a magnetic surface with a first polarity and while a magnetic surface with a second polarity covers the almost other half of shaft 28S.

Persons skilled in the art shall recognize that shaft 28S (and thus magnets 28M) can be rotated between a disengaged orientation (shown in FIG. 4A), where the resulting magnetic field does not magnetically engage the work surface (thus allowing the user to remove the drill press 10 from the work surface) and an engaged orientation (shown in FIG. 4B), where the resulting magnetic field magnetically engages the work surface (thus preventing the user to remove the drill press 10 from the work surface).

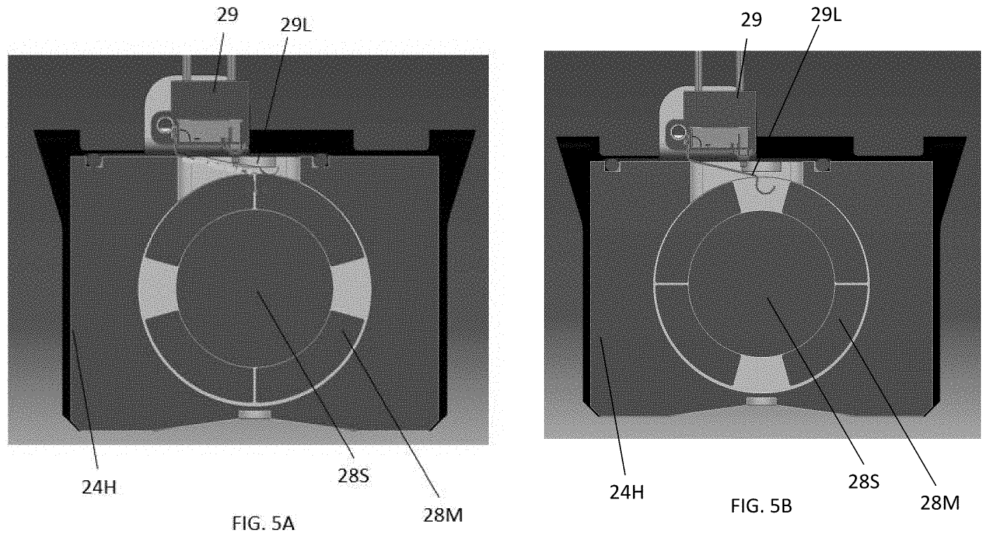

It is desirable to provide drill press 10 with a mechanism for detecting when shaft 28S and/or magnets 28M (and thus base 24) are magnetically engaged to the work surface. For example, base 24 may be provided with a switch assembly 29 (which may be removably or permanently attached to housing 24H). Switch assembly 29 may have a lever 29L which contacts magnets 28M when shaft 28S is in the disengaged orientation not magnetically engaging the work surface (as shown in FIG. 5A) and which does not contact magnets 28M when shaft 28S is in the engaged orientation magnetically engaging the work surface (as shown in FIG. 5B). With such arrangement, drill press 10 can detect when the base 24 is magnetically engaged to the work surface and will not activate the electric motor 32 when base 24 is not magnetically engaged to the work surface, even if power on/off button 19 is in the “on” position.

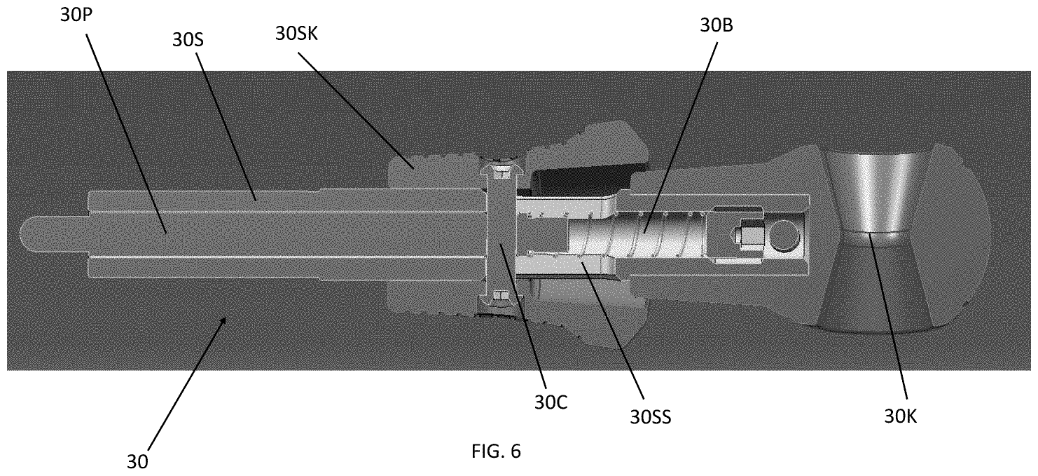

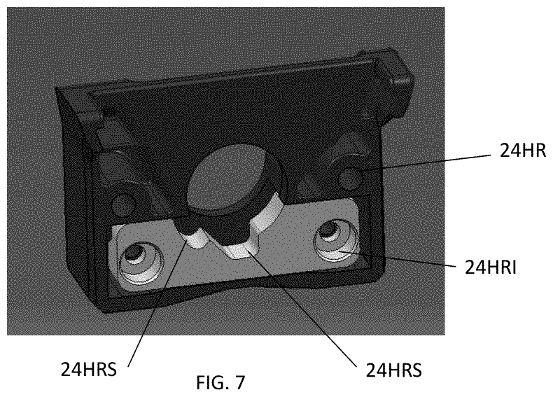

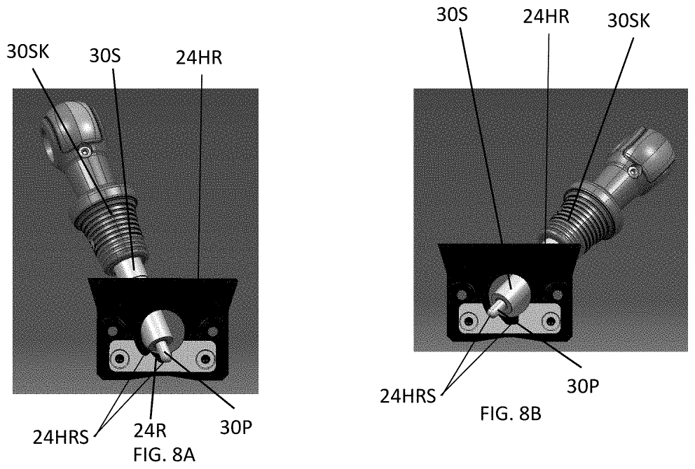

Referring to FIGS. 2-3 and 6-8B, shaft 28S (and thus magnet assembly 28) may be moved between the disengaged and engaged positions via a lever assembly 30. Preferably lever assembly 30 is fixedly attached to shaft 28S.

In particular, lever assembly 30 may have a lever shaft 30S. A knob 30K is preferably disposed at a distal end of lever shaft 30S.

It may be advantageous to provide a mechanism for keeping lever assembly 30 in at least one of the disengaged and engaged positions. One such mechanism may be provided on rear panel 24HR of housing 24H. Preferably rear panel 24HR is made of plastic or a soft metal to minimize costs. Rear panel 24HR may receive an insert 24HRI made of harder metal that can contact a portion of lever shaft 30S. Insert 24HRI may be fastened to rear panel 24HR via screws or other fasteners. Persons skilled in the art shall recognize that rear panel 24HR may be made completely of metal, so as to simplify construction thereof. Preferably insert 24HRI (and/or rear panel 24HR) will have at least one (and preferably two) slots 24HRS for receiving a portion of lever shaft 30S.

Lever assembly 30 may have a movable holding pin 30P that is movable along lever shaft 30S. Persons skilled in the art shall recognize that lever shaft 30S is preferably hollow and that holding pin 30P may be slidingly disposed therewithin.

Holding pin 30P may be attached to a sliding knob 30SK slidingly disposed on lever shaft 30S to allow the user to move holding pin 30P relative to lever shaft 30S. Sliding knob 30SK may be attached to holding pin 30P via a connector 30C extending through at least one slot (and preferably two opposite slots) 30SS in lever shaft 30S. Persons skilled in the art shall recognize that slot(s) 30SS may extend axially along lever shaft 30S to enable connector 30C (and thus holding pin 30P) to slide axially along lever shaft 30S.

A spring 30B may be captured between connector 30 (and/or holding pin 30P) and lever shaft 30S (and/or knob 30K). With such arrangement, spring 30B would bias connector 30 (and thus holding pin 30P) into engagement with notch 24HRS in rear panel 24HR (or in insert 24HRI).

With such construction, in order to move the magnet assembly 28 from the disengaged position to the engaged position, the user would pull the sliding knob 30SK towards knob 30K, disengaging holding pin 30P from the first notch 24HRS, then rotate lever assembly 30. Once the desired position is reached, the user can release the sliding knob 30SK. The spring 30B would then move holding pin 30P into engagement with the second notch 24HRS, holding the lever assembly 30 (and thus the magnet assembly 28) in the engaged position.

Persons skilled in the art shall recognize that first notch 24HRS may be provided with a ramp 24R. With such arrangement, the user would not need to pull the sliding knob 30SK towards knob 30K in order to rotate knob 30K (and thus magnet assembly 28) to the engaged position. Instead the user would just rotate knob 30K, causing holding pin 30P to slide along ramp 24R (automatically moving sliding knob 30SK towards knob 30K). Holding pin 30P will then move towards second notch 24HRS once it has cleared ramp 24R, locking magnet assembly 28 in the engaged position.

Similarly, in order to return the magnet assembly 28 to the disengaged position, the user would pull the sliding knob 30SK towards knob 30K, disengaging holding pin 30P from the second notch 24HRS, then rotate lever assembly 30 back towards the disengaged position. Once the desired position is reached, the user can release the sliding knob 30SK. The spring 30B would then move holding pin 30P into engagement with the first notch 24HRS, holding the lever assembly 30 (and thus the magnet assembly 28) in the disengaged position.

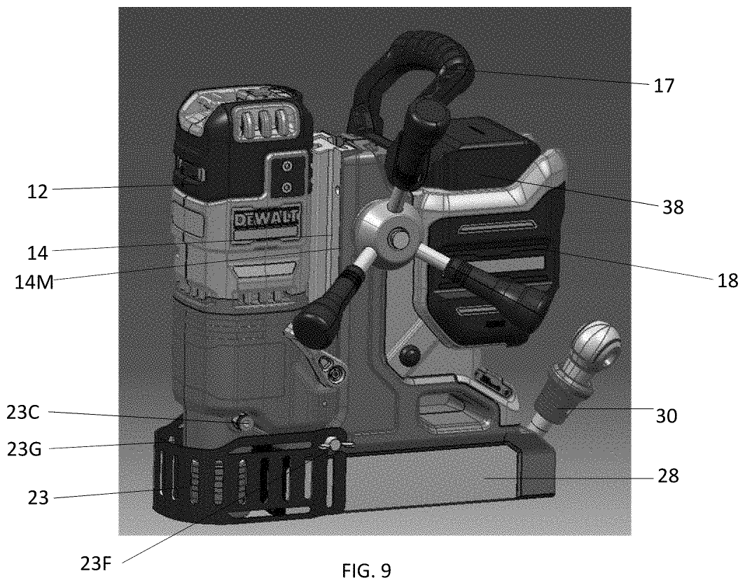

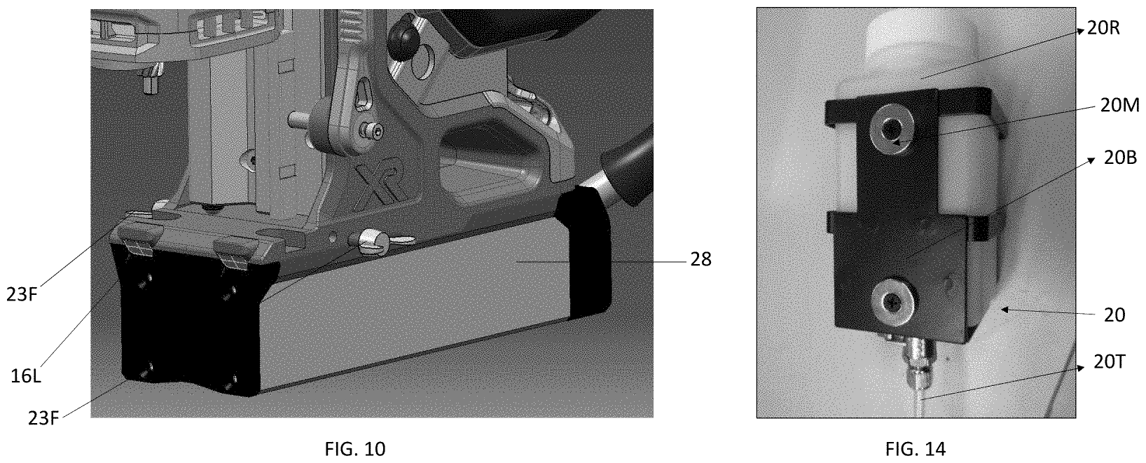

Referring to FIGS. 9-10, housing 16 may receive a power tool battery pack 38. Preferably battery 38 is rechargeable. Housing 16 may have terminals (not shown) for electrically connecting battery 38 to other electric components of drill press 10, such as electric motor 32, etc. Housing 16 may also have features, such as rails, latches, etc., for physically engaging and/or retaining battery 38 in physical connection to housing 16, thus maintaining the electrical connection between battery 38 and the other electric components.

Housing 16 may also carry at least one LED 16L for illuminating the work surface. Preferably, LED(s) 16L are powered by battery 38.

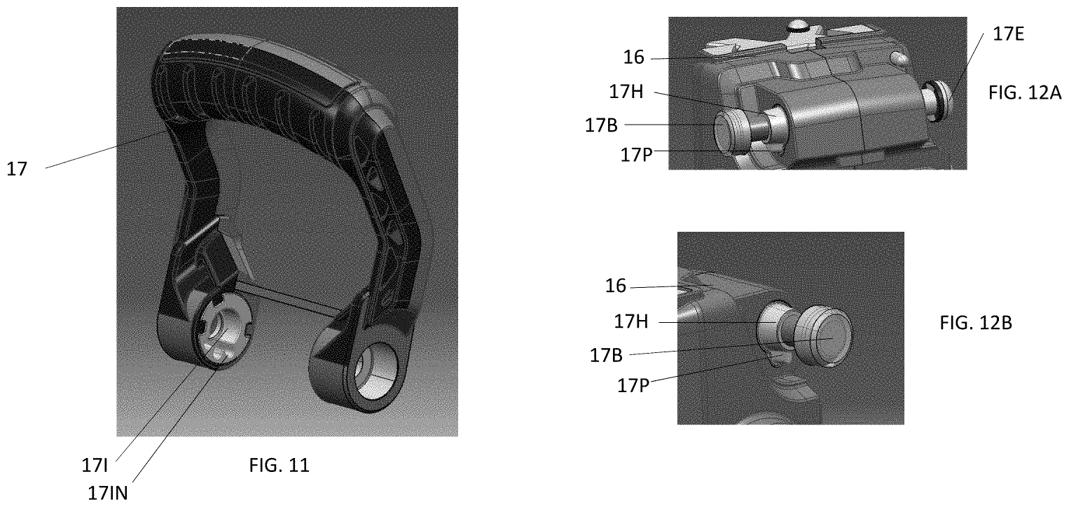

Referring to FIGS. 9 and 11-13, housing 16 preferably has an auxiliary handle 17. Preferably auxiliary handle 17 is pivotably attached to housing 16 so that it can be moved from an extended position (shown in solid lines in FIG. 9) to a lowered position (shown in broken lines in FIG. 9). In such lowered position, auxiliary handle 17 preferably contacts and/or secures battery 38 in place so that battery 38 cannot be electrically disconnected from drill press 10. Alternatively, the auxiliary handle 17 may not prevent disconnection of battery 38 from drill press 10. Instead, auxiliary handle 17 prevents battery 38 from being completely removed from drill press 10. This is especially advantageous if drill press 10 is disposed in an upside down orientation.

Auxiliary handle 17 may have a detent assembly to hold auxiliary handle 17 in the extended and lowered positions. In particular, auxiliary handle 17 may have an insert 17I, preferably made of metal, fixedly attached thereto. Insert 17I may have multiple holes or notches 17IN.

In addition, a bolt 17B may extend through auxiliary handle 17 and/or insert 17I at one end and through a second portion of auxiliary handle 17. Bolt 17B may also extend through housing 16. Preferably bolt 17B has an end cap threadingly engaged or fixedly attached thereto.

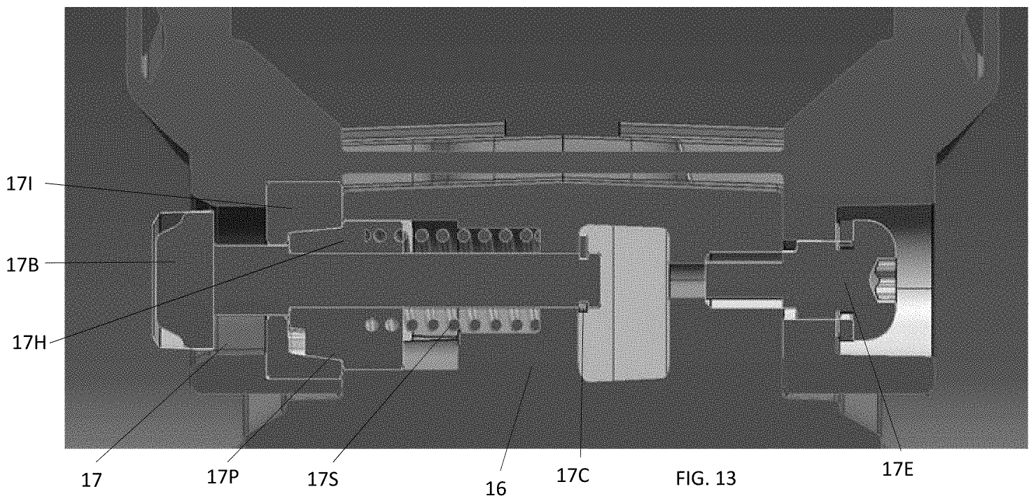

Alternatively, bolt 17B may extend through auxiliary handle 17 and/or insert 17I at one end, extend through housing 16 and be held in place by a clip 17C attached to bolt 17B, as shown in FIG. 13. A second bolt 17E may extend through the other end of the auxiliary handle 17 and be threadingly attached to housing 16.

A holder 17H may be fixedly attached or friction fit into housing 16. Holder 17H is preferably made of metal. Holder 17H may hold at least one pin or projection 17P, which can extend through the notches 17IN. Persons skilled in the art shall recognize that projection 17P is preferably integrally formed as part of holder 17H

With such arrangement, the user can press bolt 17B, disengaging projection 17P from notches 17IN, allowing the user to rotate auxiliary handle 17 relative to housing 16 towards the desired position. Once the desired rotational position is reached, the user can release bolt 17B. Preferably, a compression spring 17S is attached to or contacts bolt 17B and/or holder 17H at one end and contacts housing 16 at another end. Accordingly, when the user releases bolt 17B, the compression spring 17B biases bolt 17B outwardly, causing projection 17P to re-engage notches 17IN in the new position.

Referring to FIGS. 9 and 14, drill press 10 may have a coolant reservoir assembly 20 providing a coolant liquid, such as water, to drilling mechanism 23, in order to cool drilling mechanism 23 during operation. Coolant reservoir assembly 20 may comprise a bottle 20R for carrying the coolant liquid, a bracket 20B disposed on drill press 10 for holding bottle 20R, and a tube 20T for attached to bottle 20R at one end and to drilling mechanism 23 via coupling 23C, as is well known in the art.

Preferably bracket 20B has at least one (and preferably two) magnet(s) 20M. This allows bracket 20B (and thus coolant reservoir assembly 20) to be magnetically attached to drill press 10 and/or to the work surface. Persons skilled in the art shall recognize that motor carriage 12, housing 16 and/or rack 14 may have ferromagnetic surfaces (such as strip 14M on rack 14), allowing the user to dispose bracket 20B thereon.

Referring to FIGS. 9-10, base 24 may have a chip guard 23G attached thereto for covering drilling mechanism 23. Preferably chip guard 23G is made of a flexible metal, that can be bent around drilling mechanism 23, and fastened unto base 24 via at least one (and preferably two) wing screw(s) 23F. Chip guard 23G may have slots thereon to allow the user to view the cutting operation therethrough.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A drill press, comprising:
a main housing;
a drill unit supported by the main housing for relative movement therewith; and
a base coupled to the main housing, the base includes a magnet assembly to create a magnetic field for magnetically latching the base to a workpiece.

2. The drill press of claim 1, wherein the magnet assembly is rotatably attached to the base.

3. The drill press of claim 2, wherein the magnet assembly comprises a shaft and at least one permanent magnet disposed on the shaft.

4. The drill press of claim 3, wherein the shaft is rotatable between a first position where the base would not magnetically engage the workpiece and a second position where the base would engage the workpiece.

5. The drill press of claim 4, wherein the base further comprising a switch assembly for detecting the magnet assembly in at least one of the first and second positions.

6. The drill press of claim 4, wherein the shaft is connected to a lever assembly.

7. The drill press of claim 6, wherein the lever assembly has a lever shaft, a knob 30K being disposed at a distal end of the lever shaft, a holding pin being movable along the lever shaft, and a sliding knob attached to the holding pin, wherein the holding pin being engageable to the base.

8. The drill press of claim 1, wherein the drill unit is powered by a power tool battery pack.

9. The drill press of claim 8, wherein the power tool battery pack disposed on the main housing.

10. The drill press of claim 8, further comprising at least one LED disposed on the main housing and electrically powered by the power tool battery pack.

11. The drill press of claim 8, further comprising an auxiliary handle being pivotably attached to the main housing.

12. The drill press of claim 11, wherein the auxiliary handle being movable between a first handle position preventing removal of the power tool battery pack from the main housing and a second handle position allowing removal of the power tool battery pack from the main housing.

13. The drill press of claim 12, wherein the auxiliary handle comprises a detent assembly for holding auxiliary handle in at least one of the first and second handle positions.

14. The drill press of claim 1, further comprising a coolant reservoir assembly comprising a bottle, and a bracket for holding the bottle 20R, wherein the bracket has at least one magnet for magnetically engage the bracket to at least one of the drill press and the workpiece.
